(19) United States
(12) Patent Application Publication
(10) Pub. No.: US 2004/0126131 A1
(43) Pub. Date: Jul. 1, 2004

(54) Remanufacturing method for developer supplying device

(75) Inventors: Atsushi Numagami, Hadano-shi (JP); Kenji Matsuda, Numazu-shi (JP); Akiyoshi Fujita, Numazu-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/669,505

(22) Filed: Sep. 25, 2003

(30) Foreign Application Priority Data
Sep. 30, 2002 (JP) 285469/2002(PAT.)

(51) Int. Cl. G03G 15/00

(52) U.S. Cl. 399/109

(57) ABSTRACT

A recycling method for a developer supply unit for supplying a developer to developing means for developing an electrostatic latent image formed on an electrophotographic photosensitive member, wherein the developer supply unit is detachably mountable to a main assembly of an electrophotographic image forming apparatus and includes a developer accommodating portion for accommodating the developer, a developer supply port for supplying the developer to the developing means and a feeding member for feeding the developer to the developer supply port from the developer accommodating portion, the method includes an injection step of injecting the developer through the developer supply port; and driving step of driving the feeding member in a direction for feeding the developer from the developer supply port to the developer accommodating portion, by which the developer is fed from the developer supply port to fill the developer accommodating portion with the developer.

### FIELD OF THE INVENTION AND RELATED ART

The present invention relates to a method for remanufacturing a developer supplying unit removably mountable in the image assembly of an electrophotographic image forming apparatus.

Here, an electrophotographic image forming apparatus means an apparatus which forms an image on recording medium with the use of an electrophotographic image formation method. It includes, for example, various types of electrophotographic copying machines, electrophotographic printers (laser beam printers, LED printers, etc.), fascimileing machines, word processors, etc.

A developer supplying unit means a unit used for supplying a developing means with developer and removably mountable in the main assembly of an electrophotographic image forming apparatus.

Toner has long been used as the developer for an electrophotographic image forming apparatus such as an electrophotographic copying machine, a printer, etc. It is held in a toner supply container (developer supplying apparatus) having a toner storage portion and a toner outlet portion. A user uses a toner supply container by mounting it into an electrophotographic image forming apparatus.

When the amount of the toner in a toner supply container has reduced to a critical level due to consumption, this toner supply container can be replaced with a remanufactured toner supply container, that is, a used toner supply container refilled with toner, or a brand-new toner supply container, simplifying thereby the toner supplying operation.

Also long employed in the field of an electrophotographic image forming apparatus is a process cartridge system, according to which an electrophotographic photoconductive member, and a single or plurality of processing means among a charging means, a developing means, a cleaning means, etc., are integrally disposed in a cartridge removably mountable in the main assembly of an image forming apparatus.

A process cartridge system makes it possible for a user himself to carry out image forming apparatus maintenance, without relying on a service person, drastically increasing the operability of an image forming apparatus. Thus, a process cartridge system has been widely used in the field of an electrophotographic image forming apparatus.

Further, it has been a common practice to make a process cartridge and a toner supply container independent from each other, so that they can be individually replaced as necessary.

There are several designs for a toner supply container. According to one of the widely known toner supply container designs, a toner supply container is provided with a toner outlet having a connective portion with which the toner supply container is connected to, for example, a developing means or a toner buffer, and a movable cover for covering the toner outlet. Thus, as a toner supply container is inserted into the image forming apparatus main assembly, the cover is moved to expose the toner outlet, making it possible for the toner to be supplied to a developing means, a toner buffer, or the like.

Regarding the filling of the above described toner supply container, the toner supply container is also provided with a toner inlet, which is different from the aforementioned toner outlet. Thus, toner is filled into the toner supply container through the toner inlet. After the filling of the toner supply container, the toner inlet is plugged with a toner cap to prevent the toner from leaking.

In recent years, environmental problems have been scrutinized, increasing the need for recycling. In this kind of social climate, it has become highly important to reuse used toner supply containers.

Therefore, various methods have been proposed for remanufacturing used toner supply containers, used process cartridges, etc. (Japanese Laid-open Patent Applications 9-081013, 2000-147878, 2001-125460, 2001-125466, 2001-125467, 2001-125469, 2002-189399, etc.).

### SUMMARY OF THE INVENTION

The primary object of the present invention is to provide a simple and reliable developer supplying unit remanufacturing method which makes it possible to remanufacture a developer supplying unit by refilling the developer supplying unit with toner.

Another object of the present invention is to provide a developer supplying unit remanufacturing method which makes it possible to remanufacture a developer supplying unit by refilling the developer supplying unit with toner without damaging the developer supplying unit.

Another object of the present invention is to provide a developer supplying unit remanufacturing method which makes it possible to remanufacture a developer supplying unit by refilling the developer supplying unit with toner without removing the components from the developer supplying unit.

Another object of the present invention is to provide a developer supplying unit remanufacturing method which makes it possible to remanufacture a developer supplying unit by refilling the developer supplying unit with toner in a short time.

Another object of the present invention is to provide a method for remanufacturing a developer supplying unit which is for supplying a developing means for developing an electrostatic latent image formed on an electrophotographic photoconductive member, is removably mountable in the main assembly of an electrophotographic image forming apparatus, and comprises a developer storage portion for storing developer, a developer outlet for supplying the developing means with developer, and a conveying member for conveying developer from the developer storage portion to the developer outlet; wherein, the method comprises a toner pouring process in which toner is poured into the developer outlet, and a driving process in which the conveying member is driving in the direction to convey the poured toner from the developer outlet to the developer storage portion, and fills a developer supplying unit with developer by conveying developer from the developer outlet to the developer storage portion.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a vertical sectional view of the main assembly of the electrophotographic color image forming apparatus in the preferred embodiment of the present invention.

FIG. 2 is a vertical sectional view of the process cartridge and toner supply container in the preferred embodiment of the present invention.

FIG. 3 is a perspective view of the image forming apparatus in the preferred embodiment of the present invention, the front door of which is open.

FIG. 4 is a horizontal, lengthwise sectional view of the process cartridge in the preferred embodiment of the present invention.

FIG. 5 is a vertical, lengthwise sectional view of the toner supply container and process cartridge, in the preferred embodiment of the present invention.

FIG. 6 is a perspective view of the toner supply container in the preferred embodiment of the present invention, the toner outlet cover of which is closed.

FIG. 7 is a perspective view of the toner supply container, which is being inserted into the apparatus main assembly.

FIG. 8 is a side view of the toner supply container in the preferred embodiment of the present invention, as seen from the direction perpendicular to the lengthwise direction of the toner supply container, for showing the movement of the toner outlet cover.

FIG. 9 is an enlarged perspective view of the toner outlet portion, and its adjacencies, of the toner supply container in the preferred embodiment of the present invention.

FIG. 10 is a perspective view of the process cartridge in the preferred embodiment of the present invention.

FIG. 11 is a schematic drawing for showing the movement of the toner outlet shutter of the toner supply container in the preferred embodiment of the present invention.

FIG. 12 is an enlarged perspective view of the toner outlet portion of the toner supply container in the preferred embodiment of the present invention, the toner outlet cover of which is closed.

FIG. 13 is an enlarged perspective view of the toner outlet portion of the toner supply container in the preferred embodiment of the present invention, the toner outlet cover of which is open.

FIG. 14 is a vertical sectional view of the toner outlet portion, and its adjacencies, of the toner supply container in the preferred embodiment of the present invention.

FIG. 15 is a perspective view of the shutter retaining member of the toner supply container in the preferred embodiment of the present invention.

FIG. 16 is a vertical sectional view, parallel to the lengthwise direction of the toner supply container, of the toner supply container in the preferred embodiment of the present invention, for showing the method for filling the toner supply container with toner through the toner outlet.

FIG. 17 is a vertical sectional view, parallel to the lengthwise direction of the toner supply container, of the toner supply container in the preferred embodiment of the present invention, for showing the method for filling the toner supply container with toner through the toner outlet, with the use of a driving force generating apparatus.

FIG. 18 is a vertical sectional view, parallel to the lengthwise direction of the toner supply container, of the toner supply container in the preferred embodiment of the present invention, for showing the method for filling the toner supply container with toner through the toner outlet, with the use of a rotational force transmitting member which is to be manually rotated.

### DESCRIPTION OF THE PREFERRED EMBODIMENTS

Hereinafter, the preferred embodiments of the present invention will be described in detail with reference to the appended drawings. In the following descriptions, however, the measurements, materials, and shapes of the structural components, in the embodiments, and their positional relationships, etc., are not intended to limit the scope of the present invention, unless specifically noted.

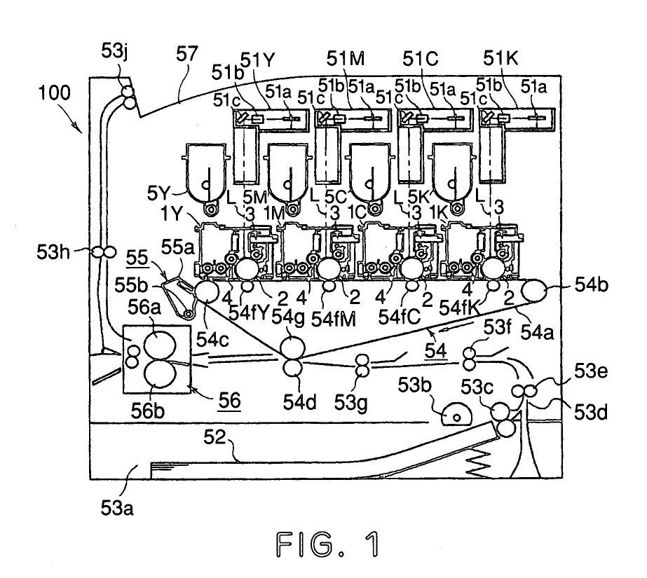

Referring to FIGS. 1-16, the embodiments of the present invention will be described.

First, the electrophotographic color image forming apparatus in this embodiment of the present invention will be described with reference to the appended drawings. In the following descriptions of the embodiments, the lengthwise direction means the direction parallel to the axial line of an electrophotographic photoconductive drum (which hereinafter will be referred to as photoconductive drum 2). Further, with reference to the direction in which a cartridge is inserted into an electrophotographic image forming apparatus, the downstream side of the cartridge insertion direction is considered to be the back side, whereas the downstream side of the direction in which a cartridge is pulled out of an electrophotographic image forming apparatus, that is, the upstream side of the cartridge insertion direction, is designated as the front side. The top and bottom sides of a cartridge mean the top and bottom sides of the cartridge properly situated in the main assembly of an electrophotographic image forming apparatus.

[Description of General Structure of Image Forming Apparatus]

First, referring to FIG. 1, the general structure of a typical electrophotographic color image forming apparatus will be described. FIG. 1 is a drawing for describing the general structure of a color laser beam printer (which hereinafter may be simply referred to as image forming apparatus), that is, one form of an electrophotographic color image forming apparatus.

The image forming portion of this electrophotographic image forming apparatus 100 in this embodiment employs four process cartridges 1 (1Y, 1M, 1C, and 1K corresponding to yellow, magenta, cyan, and black color components, respectively). The image forming portion also has four exposing means (laser beam optical scanning system) 51 (51Y, 51M, 51C, and 51K), which are disposed in parallel and are aligned in the horizontal direction. The four exposing means 1 are located above the process cartridges 1 (1Y, 1M, 1C, and 1K), being roughly vertically aligned one for one with the four process cartridges 1.

Disposed below the above described image forming portion is a feeding means for feeding a recording medium 52 into the main assembly, and an intermediary transfer unit 54 having an intermediary transfer belt 54a onto which a developer image formed on the photoconductive drum 2 is transferred, and a secondary transfer roller 54d for transferring the developer images on the transfer belt 4a, onto the recording medium 52 on the intermediary transfer belt 54a.

The image forming apparatus is also provided with a fixing means 56 for fixing the toner images which have been transferred onto the recording medium 52, and discharge rollers 3h and 3j for discharging the recording medium 52 out of the image forming apparatus main assembly and accumulating it.

The recording medium 52 is, for example, a piece of recording paper, OHP sheet, fabric, or the like.

The image forming apparatus 100 in this embodiment is a cleaner-less apparatus. Thus, the transfer residual toner, that is, the toner remaining on the photoconductive drum 2 after transfer is taken in by the developing means. Therefore, the process cartridge 1 is not provided with a cleaner dedicated to the recovery and storage of the transfer residual toner.

Next, the structures of the various portions of the image forming apparatus 100 will be described in detail in the logical order.

[Feeding Portion]

The feeding portion is a portion for conveying the recording medium 52 to the image forming portion. It essentially comprises: a feeding cassette 53a which holds a plurality of recording mediums 52; a feed roller 53b; a pair of retard rollers 53c for preventing two or more recording mediums 52 from being fed at the same time; a guide 53d; and a pair of registration rollers 53g.

The recording medium 2 is conveyed to the registration rollers 3g by the conveying rollers 3e and 3f while being guided by the guide 3d.

The feeding roller 53b is rotationally driven in synchronism with an image forming operation, taking the recording mediums 52, virtually one by one, out of the feeding cassette 53a and feeding them into the apparatus main assembly.

As the recording mediums 52 are fed into the apparatus main assembly, they are prevented by the retard rollers 53c from being fed at the same time. Then, the recording mediums 52 are conveyed to the registration rollers 53g, by way of conveyance rollers 53e and 53f, while being guided by the conveyance guide 53d.

During an image forming operation, the registration rollers 53g repeat the sequence of being kept stationary for keeping a recording medium 52 on standby, and being rotated for conveying the recording medium 52 toward the intermediary transfer belt 54a, in order to align a toner image with the recording medium 52 during the subsequent transfer process.

Immediately after the release of the recording medium 52, the rotation of the registration rollers 53g is stopped, and the registration rollers 53g are again kept stationary. Then, the following recording medium 52 collides with the nip portion between the two registration rollers 53g, being thereby unslanted.

[Process Cartridge]

A process cartridge means a cartridge in which a charging means, and a developing meaning or cleaning means, are integrally disposed along with an electrophotographic photoconductive drum, and which is removably mountable in the main assembly of an electrophotographic image forming apparatus, or a cartridge in which at least one means among a charging means, a developing means, and a cleaning means, is integrally disposed along with an electrophotographic photoconductive drum, and which is removably mountable in the main assembly of an electrophotographic image forming apparatus. It also means a cartridge in which a minimum of a developing apparatus is integrally disposed along with an electrophotographic photoconductive drum, and which is removably mountable in the main assembly of an electrophotographic image forming apparatus. In this embodiment, the image forming apparatus 100 is of a cleaner-less type, which will be described later. Thus, the process cartridges 1Y, 1M, 1C, and 1K for this image forming apparatus are cartridges in which a charging means and developing means are integrally disposed along with an electrophotographic photoconductive drum, and which are removably mountable in the main assembly of the image forming apparatus 100.

In each of the process cartridges 1Y, 1M, 1C, and 1B, a charging means and a developing means are integrally disposed around the peripheral surface of the photoconductive drum 2. These process cartridges 1 can be easily removed from the image forming apparatus 100, and are to be replaced at the end of the service life of the photoconductive drum 2.

As for the method for determining whether or not the service life of the process cartridge 1 has reached its end, the rotations of the photoconductive drum 2 are counted, and as the cumulative number of the rotations exceeds a predetermined value, a user is warned that the service life of the process cartridge 1 has reached its end.

The photoconductive drum 2 in this embodiment is an organic photoconductive member, the inherent polarity of which is negative. It comprises a hollow aluminum cylinder, as a base member 2h, with a diameter of approximately 30 mm, a layer of an ordinary photoconductive substance coated on the peripheral surface of the base member 2h, and a charge injection layer as an outermost layer coated on the photoconductive layer. It is rotationally driven at a predetermined process speed, which in this embodiment is approximately 117 mm/sec.

The charge injection layer is a coated layer of a mixture of insulating resin as binder, and microparticles of electrically conductive substance, for example, SnO2, dispersed in the binder.

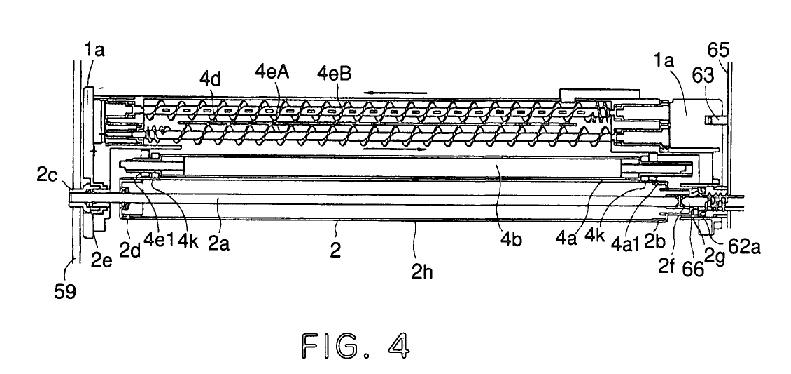

Referring to FIG. 4, the photoconductive drum 2 is provided with a drum flange 2b, which is solidly attached to the back end (right end in FIG. 4) of the base drum 2h of the photoconductive drum 2 in terms of the lengthwise direction of the photoconductive drum 2, and a drum flange 2d, which is solidly attached to the front end (left end in FIG. 4) of the base drum 2h, from which the photoconductive drum 2 is not driven. The photoconductive drum 2 is also provided with a drum shaft 2a, which penetrates the centers of the drum flanges 2b and 2d. The drum shaft 2a is connected to the flange 2d so that it rotates with the flange 2d, that is, the flange on the side from which the photoconductive drum 2 is not driven, which hereinafter will be referred to as non-driven flange 2d. The base drum 2h, drum shaft 2a, drum flange 2b, and non-driven flange 2d are rotated together. In other words, the photoconductive drum 2 is rotated about the axis of the drum shaft 2a.

The front end portion of the drum shaft 2a is rotationally supported by a bearing 2e, which is solidly fixed to a case 2c, which is solidly fixed to the frame 1a of the process cartridge 1.

[Charging Means]

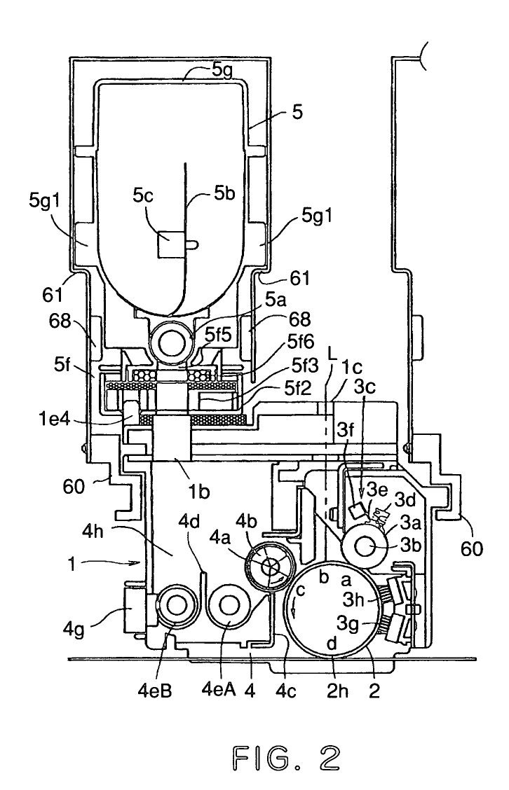

Referring to FIG. 2, the charging means in this embodiment employs one of the contact type charging methods. It employs a charge roller 3a as a charging member. The charge roller 3a is rotatably supported by a pair of bearings (unshown), at the lengthwise end portions of its metallic core 3b. It is kept pressured toward the photoconductive drum by a pair of compression springs 3d; it is kept in contact with the peripheral surface of the photoconductive drum 2, so that a predetermined amount of contact pressure is maintained between the photoconductive drum 2 and the charge roller 3a. It is rotated by the rotation of the photoconductive drum 2.

Designated by a referential number 3c is a cleaning member for cleaning the charge roller 3a. The charge roller cleaning member 3c in this embodiment has a flexible cleaning film 3e, which extends in the lengthwise direction of the charge roller 3a, in parallel to the charge roller 3a. The cleaning film 3e is solidly fixed, by one of the long edges thereof, to a supporting member 3f which is reciprocally moved a predetermined distance in the lengthwise direction of the charge roller 3a. The cleaning film 3e is disposed so that the free long edge portion of the cleaning film 3e forms a contact nip against the peripheral surface of the charge roller 3a. Thus, as the supporting member 3f is reciprocally moved by an external driving means, the peripheral surface of the charge roller 3a is rubbed by the cleaning film 3e. As a result, the contaminants (minute particles of toner, external additive, etc.) adhering to the peripheral surface of the charge roller 3a are removed.

Incidentally, the image forming apparatus 100 in this embodiment is of a cleaner-less type. Next, the cleaner-less system will be described.

[Cleaner-Less System]

Referring to FIG. 2, the outline of the cleaner-less system of the image forming apparatus 100 in this embodiment will be described. The transfer residual toner, that is, the toner remaining on the photoconductive drum 2 after the aforementioned toner image transfer is conveyed further by the subsequent rotation of the photoconductive drum 2 through the charging portion a and exposing portion b, and into the development portion c, in which the transfer residual toner is recovered (photoconductive drum is cleaned) by the developing means at the same time as a latent image on the photoconductive drum 2 is developed by the developing means.

Since the transfer residual toner on the peripheral surface of the photoconductive drum 2 is moved past the exposing portion b, the peripheral surface of the photoconductive drum 2 is exposed through the transfer residual toner thereon. However, the transfer residual toner is very small in quantity, not significantly affecting the exposing process.

Incidentally, in terms of polarity, the transfer residual toner is a mixture of normally charged toner particles and reversely charged toner particles (reversal toner particles), and, in terms of the amount of charge, it is a mixture of fully charged toner particles and insufficiently charged toner particles. It is possible that these reversely charged toner particles and insufficiently charged toner particles are likely to adhere to the charge roller 3a, contaminating thereby the charge roller 3a, beyond the permissible level, that is, seriously enough for the photoconductive drum 2 to be insufficiently charged.

In order to assure that the transfer residual toner on the peripheral surface of the photoconductive drum 2 is satisfactorily removed by the developing apparatus at the same time as a latent image on the peripheral surface of the photoconductive drum 2 is developed by the developing apparatus, it is necessary that the transfer residual toner, on the peripheral surface of the photoconductive drum 2, which is to be conveyed to the developing portion c, is positive in polarity, and also that the amount of electrical charge of the transfer residual toner is equal to the value which makes it possible to develop the electrostatic latent image on the photoconductive drum 2 by the developing apparatus. The reversely charged toner particles, and the insufficiently charged toner particles, cannot be removed from the peripheral surface of the photoconductive drum 2 by the developing means, and therefore, cannot be recovered, causing therefore the formation of an image of poor quality.

In recent years, user needs have diversified. One of the diversified user needs is to print an image with a higher printing ratio, for example, a photographic image, which requires a continuous long printing operation, generating all at once a substantial amount of transfer residual toner, exacerbating thereby the above described problem.

In this embodiment, therefore, a transfer residual toner distributing means 3g (means for erasing residual developer image) for evenly distributing the transfer residual toner particles on the photoconductive drum 2, is disposed on the downstream side of the transfer portion d, in terms of the rotational direction of the photoconductive drum 2. Further, in order to make all the transfer residual toner particles normally charged, that is, negatively charged, a toner charge controlling means 3h for charging the reversely charged toner particles to negative polarity, is disposed between the downstream side of the transfer residual toner distributing means 3g, and the upstream side of the charging portion a, in terms of the rotational direction of the photoconductive drum 2.

With the provision of the transfer residual toner distributing means 3g, the transfer residual toner particles, which are remaining, in a certain pattern, on the photoconductive drum 2, are conveyed from the transfer portion d to the toner charge controlling means 3h, are evenly distributed across the peripheral surface of the photoconductive drum 2, losing therefore the pattern in which they have been adhering to the peripheral surface of the photoconductive drum 2, even if their amount is substantial. Therefore, the problem that the toner particles concentrate on certain portions of the toner charge controlling means 3h is eliminated, assuring thereby that the reversely charged residual toner particles are normally charged by the toner charge controlling means 3h so that all of the transfer residual toner particles become normal in polarity. Therefore, the adhesion of the transfer residual toner to the charge roller 3a is effectively prevented, and also the creation of a ghost image reflecting the pattern in which the transfer residual toner particles remain on the photoconductive drum 2 is prevented.

The transfer residual toner distributing means 3g and toner charge controlling means 3h, in this embodiment, are in the form of a brush with a proper degree of electrical conductivity, and are placed in contact with the photoconductive drum 2, with their brush portions in contact with the peripheral surface of the photoconductive drum 2.

These means 3g and 3h are structured so that they are moved (reciprocally) in the lengthwise direction of the photoconductive drum 2, by an unshown driving force source. With the provision of this structural arrangement, the transfer residual toner distributing means 3g and toner charge controlling means 3h do not remain in contact with the same ranges of the peripheral surface of the photoconductive drum 2. Therefore, it does not occur that a given portion of the peripheral surface of the photoconductive drum 2 is always contacted by the same portion of the toner charge controlling means 3h. Thus, even if the irregularity in electrical resistance across the toner charge controlling means 3h makes some portions of the toner charge controlling means 3h excessive in charging performance, and the other portions insufficient in charging performance, the problem that the excessively charged transfer residual toner particles adhere to certain areas of the peripheral surface of the photoconductive drum 2, and/or the problem that the insufficiently charged transfer residual toner particles adhere to certain areas of the peripheral surface of the charge roller 3a, are prevented or mitigated.

[Exposing Means]

In this embodiment, the aforementioned photoconductive drum 2 is exposed by a laser exposing means. More specifically, as image formation signals are sent to the exposing means from the image forming apparatus 100, a beam of laser light L is projected from the exposing means, while being modulated with the image formation signals, onto the photoconductive drum 2, in a manner to scan the uniformly charged portion of the peripheral surface of the photoconductive drum 2, selectively exposing numerous points on the uniformly charged portion of the peripheral surface of the photoconductive drum 2. As a result, an electrostatic latent image in accordance with the image formation information is formed on the peripheral surface of the photoconductive drum 2.

Referring to FIG. 1, the laser exposing means comprises: a solid laser element (unshown), a polygon mirror 51a, a focusing lens 51b, a reflection mirror 51c, etc.

In operation, the solid laser element is turned on and off by an optical signal generating device (unshown), in response to the inputted image formation signals. The beam of laser light L irradiated from the solid laser element is converted by a collimator lens system (unshown) into a virtually parallel beam of light, and is projected onto the polygon mirror 51a, which is being rotated at a high peripheral velocity. As a result, the parallel beam of light is oscillated in a scanning manner. Then, it is further projected by way of the focusing lens 51b and reflection mirror 51c, forming an oscillating spot of light on the peripheral surface of the photoconductive drum 2.

Thus, as the spot of light oscillates, the peripheral surface of the photoconductive drum 2 is exposed in the primary scanning direction, and as the photoconductive drum 2 is rotated, it is exposed in the secondary scanning direction. As a result, numerous points on the peripheral surface of the photoconductive drum 2 are exposed or remain unexposed in such a manner that the distribution of the exposed and unexposed points reflects the image formation signal sequence. In other words, the points (exposed points) with the reduced potential level, and the points (unexposed points) with the normal potential level, are created, the contrast among which generates an electrostatic latent image in accordance with the image formation information.

[Developing Apparatus]

The developing apparatus 4 is of a contact type developing apparatus which uses two-component developer (two-component magnetic brush type developing apparatus). Referring to FIG. 2, the developing apparatus 4 comprises a development sleeve 4a as a developer bearing member, and a magnetic roller 4b disposed within the hollow of the development sleeve 4a. The development sleeve 4a holds a layer of developer, which is a mixture of carrier and toner, on its peripheral surface. This development sleeve 4a is the actual developing means. The developing apparatus 4 also comprises a regulating blade 4c, which is disposed in the adjacencies of the peripheral surface of the development sleeve 4a, with the presence of a predetermined distance from the development sleeve 4a. As the development sleeve 4a is rotated in the direction indicated by an arrow mark, a thin layer of developer is formed on the peripheral surface of the development sleeve.

Incidentally, the developing apparatus 4 in this embodiment is a two-component magnetic brush type developing apparatus. However, the developing apparatus 4 does not need to be of a two-component magnetic brush type.

Referring to FIG. 4, the development sleeve 4a is provided with a pair of ring-shaped spacers 4k, which are rotatably fitted around the journal portions 4a1, that is, the lengthwise end portions of the development sleeve 4a, one for one, which are smaller in diameter than the developer carrying portion of the development sleeve 4a. With the provision of the spacers 4k, a predetermined gap is maintained between the development sleeve 4a and photoconductive drum 2 so that during a development operation, only the developer layer formed on the peripheral surface of the development sleeve 4a touches the photoconductive drum 2. Referring to FIG. 2, the development sleeve 4a is rotationally driven in the counterclockwise direction indicated by an arrow mark at a predetermined peripheral velocity so that, in the development portion c, the peripheral surface of the development sleeve 4a moves in the direction counter to the moving direction of the peripheral surface of the photoconductive drum 2.

The toner in this embodiment is such toner that is negative in inherent polarity and is 6 μm in average particle diameter. The magnetic carrier in this embodiment is 205 emu/cm³ in saturation magnetization, and is 35 μm in average particle diameter. The ratio in weight between the toner and carrier in the developer is 6:94. However, the developer choice does not need to be limited to a mixture of toner and magnetic carrier. For example, magnetic toner may be used.

Referring to FIG. 2, the developer storage portion 4h, in which the developer is circulated, has two chambers divided by a partitioning wall 4d which extends in the lengthwise direction. The developer storage portion 4h has stirring screws 4eA and 4eB, which are disposed on both sides of the partitioning wall 4d, one for one.

Referring to FIG. 4, as the toner is supplied to the developer storage portion 4h from the developer supply container (developer supplying apparatus), the toner falls onto the back end portion (right end portion in FIG. 4) of the stirring screw 4eB, and is conveyed frontward (left end portion in FIG. 4) of the apparatus, in terms of the lengthwise direction, while being stirred. Then, it is moved through the gap between the front wall of the developer storage portion 4h and the partitioning wall 4d, and then, is conveyed backward (rightward in FIG. 4) of the developer storage portion 4h, in terms of the lengthwise direction, by the stirring screw 4eA. Then, it is moved through the gap between the back wall of the developer storage portion 4h and the partitioning wall 4d. In other words, the developer is repeatedly circulated by the stirring screws 4eB and 4eA in the developer storage portion 4h.

At this time, referring to FIG. 2, the development process for developing an electrostatic latent image formed on the photoconductive drum 2 into a visible image with the use of the developing apparatus 4 which employs a two-component magnetic brush developing method, and the developer circulating system, will be described.

As the development sleeve 4a is rotated, the developer in the developer storage portion 4h is picked up and held to the peripheral surface of the development sleeve 4a, by the pickup pole of the magnetic roller 4b, and is conveyed further.

While being conveyed after being held to the peripheral surface of the development sleeve 4a, the body of developer is regulated in thickness by the development blade 4c disposed perpendicular to the peripheral surface of the development sleeve 4a. As a result, a thin layer of developer is formed on the peripheral surface of the development sleeve 4a.

As the thin layer of developer reaches the development portion c, which corresponds in position to the development pole of the magnetic roller 4b, the developer layer is made to crest by the magnetic force. Thus, the electrostatic latent image on the peripheral surface of the photoconductive drum 2 is developed into a visible image, by the toner in the crest of the developer layer. Incidentally, in this embodiment, an electrostatic latent image is developed in reverse.

After being conveyed and passed through the development portion c, the thin layer of developer on the peripheral surface of the development sleeve 4a is made to enter the developer storage portion 4h, by the subsequent continual rotation of the development sleeve 4a. In the developer storage portion 4h, the developer layer is made to separate from the peripheral surface of the development sleeve 4a, by the repulsive magnetic field of the conveyance pole, and fall into the developer storage portion 4h. In other words, it is returned to the developer storage portion 4h.

To the development sleeve 4a, a combination of DC voltage and AC voltage is applied from an unshown electrical power source. In this embodiment, the combination of a DC voltage of −500 V and an AC voltage which is 2,000 Hz in frequency, and 1,500 V in peak-to-peak voltage, is applied to develop only the exposed points of the peripheral surface of the photoconductive drum 2.

Generally, in a two-component developing method, the application of AC voltage increases development efficiency, making it possible to form an image of higher quality. On the other hand, the application of AC voltage is likely to result in the formation of a foggy image. Therefore, it is a common practice to create a certain amount of difference in potential level between the potential level of the DC voltage applied to the development sleeve 4a and the potential level of the peripheral surface of the photoconductive drum 2 in order to prevent the formation of a foggy image. More specifically, bias voltage (AC voltage), the potential level of which falls between the potential level of an exposed point of the peripheral surface of the photoconductive drum 2, and the potential level of an unexposed point of the peripheral surface of the photoconductive drum 2, is applied.

As the toner is consumed by the development of an electrostatic latent image, the toner content of the developer decreases. In this embodiment, a sensor 4g for detecting the toner content is disposed in the adjacencies of the peripheral surface of a developer stirring screw 4cB, as shown in FIG. 2. As it is detected by the sensor 4g that the toner content of the developer has reduced below a predetermined level, a command for supplying the developer storage portion 4h of the developing apparatus 4 with the toner from the toner supply container 5 is issued to initiate a toner supplying operation, which maintains the toner content of the developer in the developing apparatus at a predetermined level.

[Toner Supply Container]

The toner supply containers 5Y, 5M, 5C, and 5K are disposed in parallel above the process cartridges 1Y, 1M, 1C, and 1K, respectively, and are mounted into the image forming apparatus 100 from the front side of the apparatus 100.

Referring to FIG. 2, the toner supply container 5 has a frame 5g as the toner storage portion (developer storage portion), in which toner, or a mixture of toner and magnetic carrier is stored. Within the toner supply container 5, a stirring plate 5b solidly fixed to a stirring shaft 5c, and a screw 5a (conveying member), are disposed. The bottom wall of the toner supply container 5 is provided with a toner outlet 5f having a developer releasing hole through which the toner is discharged into a process cartridge.

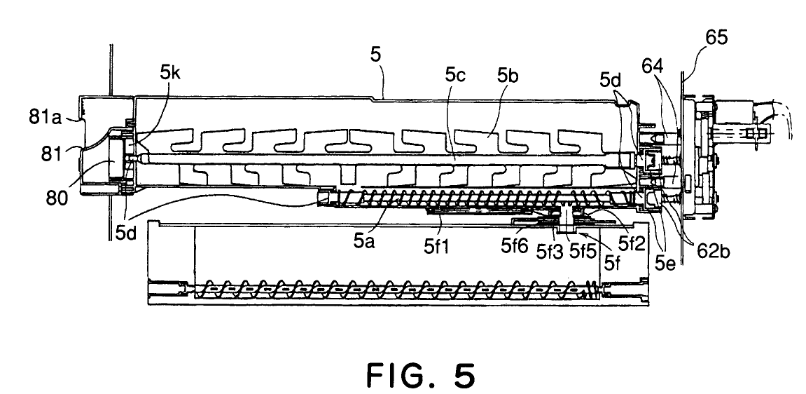

Referring to FIG. 5, the screw 5a and stirring shaft 5c are rotatably supported by bearings 5d, by their lengthwise ends. The screw 5a is provided with a driving coupling (female coupling) 5e, which is attached to the back end (right end in FIG. 5) of the screw 5a, and the stirring shaft 5a is also provided with a driving coupling (female coupling) 5e, which is attached to the back end (right end in FIG. 5). The driving couplings (female couplings) 5e receive the driving force transmitted through the driving couplings (male couplings) 62d, one for one, of the image forming apparatus 100, being thereby rotationally driven.

The screw 5a comprises two pieces of spiral ribs located on one side of the toner outlet 5f and the other, and twisted in the opposite direction. The screw 5a is rotated in the predetermined direction by the rotation of the driving coupling 62b.

As a result, the toner is conveyed toward the toner outlet 5f, and free falls through the first toner releasing hole of the toner outlet 5f into the process cartridge 1; in other words, the process cartridge 1 is supplied with the toner.

The peripheral edge, that is, the outermost edge of each section of the stirring plate 5b, in terms of the rotational radius of the developer sending member 5b, is angled relative to the stirring shaft 5c. Thus, as each section of the stirring plate 5b rubs against the internal surface of the toner supply container 5, its peripheral edge portion is angled at certain degrees relative to its base portion. More specifically, the peripheral edge portion of each section of the stirring plate 5b is spirally twisted. Thus, as the stirring shaft 5c is rotated, the toner in the toner supply container 5 comes into contact with the spirally twisted edge portions of the stirring plate 5c, being thereby conveyed in the lengthwise direction of the stirring shaft 5c.

Not only can the toner supply container in this embodiment supply toner to a process cartridge, or a development cartridge, which employs a two-component developing method, but also to a process cartridge or a development cartridge, which employs a single-component developing method. Further, the powder to be stored in the toner supply container does not need to be limited to toner. For example, it may be the so-called developer, that is, a mixture of toner and magnetic carrier, which is needless to say.

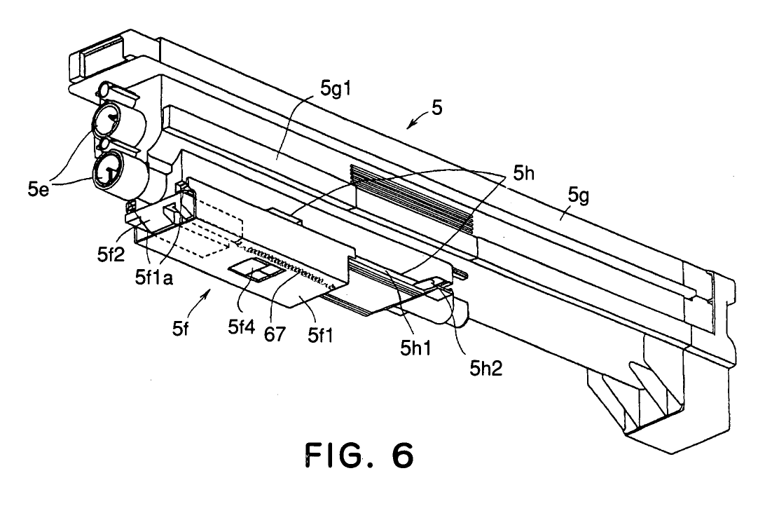

Referring to FIG. 6 which is a perspective view of the toner supply container 5 as seen from below the back end thereof, the toner supply container 5 is provided with a pair of guiding portions 5g1, which are on the lengthwise lateral walls, one for one, of the frame 5g as the toner storage portion of the toner supply container 5, and which function as guides when the toner supply container 5 is inserted into the image forming apparatus 100.

The guiding portion 5g1 is rectangular in cross section, and extends straight in the lengthwise direction, on the corresponding lengthwise lateral wall of the toner supply container 5. With respect to the vertical direction of the toner supply container, the bottom surface of the guiding portion 5g1 is flat. When the toner supply container 5 is mounted into the image forming apparatus 100, the toner supply container 5 rides on the pair of guide rails 61 of the image forming apparatus 100, with the bottom surface of each guiding portion of the toner supply container 5 remaining in contact with the top surface of the corresponding guide rail 61 of the image forming apparatus 100, being thereby accurately positioning the toner supply container 5 relative to the image forming apparatus 100 in terms of the vertical direction (FIG. 2).

The toner supply container 5 is also provided with a toner outlet cover 5f1 for covering the opening of the toner outlet 5f located at the bottom of the toner supply container 5. The toner outlet cover 5f1 is movable in the lengthwise direction of the toner supply container 5.

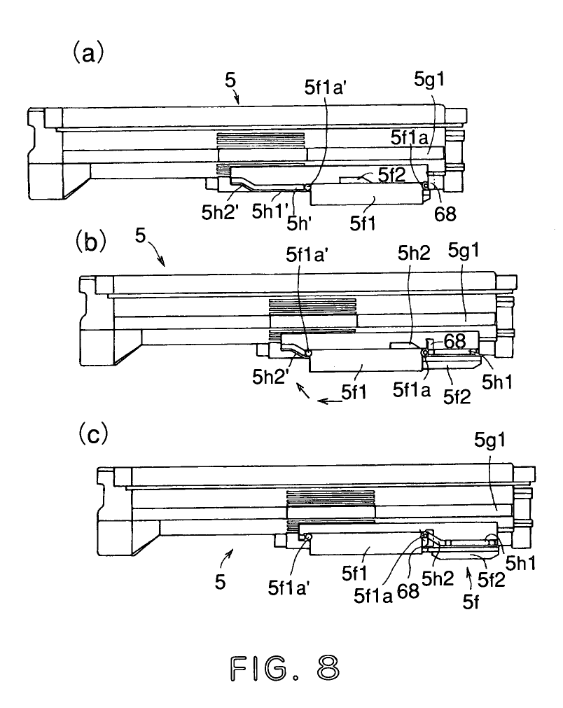

Referring to FIG. 8(a), before the insertion of the toner supply container 5 into the image forming apparatus 100, the toner outlet cover 5f1 is in the first position in which it covers the opening of the toner outlet 5f. In this position, the end 5f1a′ of the toner outlet cover 5f1 is in contact with the right end of the rail 5h′, preventing the toner outlet cover 5f1 from moving rightward.

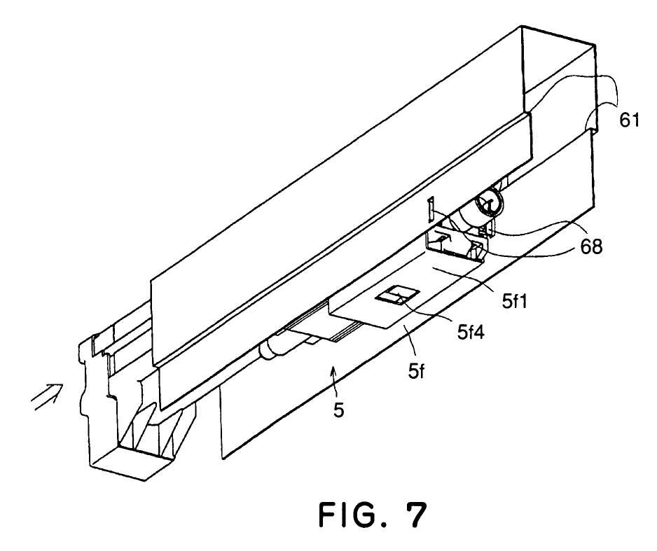

As the toner supply container 5 is inserted into the image forming apparatus 100, the guide rails 61 of the image forming apparatus 100 support the toner supply container 5 in such a manner that the guiding portions 5g of the toner supply container 5 slide on the guide rails 61. During this insertion of the toner supply container 5, the leading end of the toner outlet cover 5f1, in terms of the toner supply container insertion direction, comes into contact with the projection 68 of the image forming apparatus 100, as shown in FIG. 7.

Referring to FIG. 8(b), as the toner supply container 5 is further inserted from the point of contact between the toner outlet cover 5f1 and projection 68, the toner outlet cover 5f1 is kept stationary by the projection 68 even though the other portions of the toner supply container 5 are further inserted. In other words, the toner outlet cover 5f1 is moved backward, in terms of the toner supply container insertion direction, relative to the toner supply container 5, while the stretching the tension coil spring 67.

Next, referring to FIG. 8(c), also in terms of the position of the toner outlet cover 5f1 relative to the main assembly of the toner supply container 5, the toner outlet cover 5f1 slides along the rails 5h and 5h′ until it slides into the second position in which it exposes the retaining member 5f2 by which the toner supply container 5 is connected to the process cartridge 1.

Next, this movement of the toner outlet cover 5f1 will be described in detail with reference to FIG. 8, which is a side view of the toner supply container 5, as seen from the direction perpendicular to the lengthwise direction of the toner supply container 5, for sequentially showing the states of the toner supply container 5 through which the toner supply container 5 is inserted into the image forming apparatus 100. The insertion progresses from the state of toner supply container 5 shown in FIG. 8(a) to that in FIG. 8(c).

As described above, after coming into contact with the projection 68 of the image forming apparatus 100, the toner outlet cover 5f1 is moved along the first portions 5h1 and 5h1′ of the rails 5h and 5h′, respectively, relative to the toner supply container 5 in the virtually horizontal direction, that is, the direction virtually parallel to the toner supply container insertion direction. Then, it is moved along the second portions 5h2 and 5h2′ of the rails 5h and 5h′, respectively, being thereby moved in the upward direction, that is, the direction to move away from the process cartridge 1 having the developing means. As a result, the retaining member 5f2 is exposed.

In reality, during the insertion of the toner supply container 5 into the image forming apparatus 100, the toner outlet cover 5f1 does not move in the roughly horizontal direction. In fact, it simply retracts upward by being guided by the second portions 5h2 and 5h2′ of the rails 5h and 5h′.

The toner outlet cover 5f1 is provided with two latching portions 5f1a and 5f1a′, which are on each lateral wall of the toner outlet cover 5f1, and the distance between which is the same as the distance between the two second portions 5h2 and 5h2′ of the rails 5h and 5h′, respectively, of each of the lateral walls of the toner supply container 5. Thus, the toner outlet cover 5f1 is retracted upward into the second position, its attitude remaining virtually the same as that when it is in the first position.

With the provision of the above described structural arrangement, as the toner supply container 5 is inserted into the image forming apparatus 100, the toner outlet cover 5f1 is retracted in the direction (upward in FIG. 8) to move away from the process cartridge 1 as the developing means. Therefore, the position, into which the toner outlet cover 5f1 is to be retracted as the toner supply container 5 is inserted into the image forming apparatus 100, has no effect on the positioning of the process cartridge 1, contributing to efficient space utilization.

Incidentally, in this embodiment, the process cartridge 1 and toner supply container 5 can be mounted into, or dismounted from, the image forming apparatus 100 at random. In other words, it is possible that the toner supply container 5 is in the image forming apparatus 100 before the mounting of the process cartridge 1.

In such a case, the problem occurs that the simple horizontal retraction of the toner outlet cover 5f1 from the first position allows the toner outlet cover 5f1 to come into contact with the toner inlet 1b of the process cartridge 1.

In order to prevent this problem by the structural modification on the process cartridge side, the process cartridge 1 must be structured so that the toner inlet 1b can be retracted. It is possible that such a structural arrangement makes the toner inlet 1b extremely complicated in structure. In comparison, the structural arrangement in this embodiment makes the toner outlet cover 5f1 of the toner supply container 5 retract in the direction to move away from the process cartridge 1, solving the above described problem.

When the toner supply container 5 is removed from the image forming apparatus 100, it is moved back by the resiliency of the unshown tension coil spring into the first position, following in reverse the steps it went through when mounted.

Further, the toner supply container 5 is provided with a toner outlet shutter 5f3, which is disposed so that, when the toner supply container 5 is mounted into the image forming apparatus 100, the toner outlet cover 5f1 is moved into the second position (open position) before the toner outlet shutter 5f3 is moved from the closed position to the open position, and also that when the toner supply container 5 is removed from the image forming apparatus 100, the toner outlet cover 5f1 is moved from the open position to the closed position after the toner outlet shutter 5f3 is moved from the open position to the closed position.

Next, the structural arrangement for preventing the toner leak of the toner supply container 5 will be described. Referring to FIGS. 2 and 5, the toner supply container 5 is provided with the toner outlet 5f, which is attached to the bottom wall of the frame 5g of toner supply container 5, and through which the toner in the toner supply container 5 is discharged into the process cartridge 1. The bottom wall of the frame 5g of the toner supply container 5 is provided with a hole as the first hole 5f5 of the toner outlet 5f which is in the center of the toner outlet 5f.

The toner outlet 5f has a sealing member 5f6, which is bonded to the bottom wall of the frame 5g of the toner supply container 5 in a manner to surround the top edge of the first hole 5f5.

In this embodiment, the toner outlet 5f is located close to the lengthwise end of the toner supply container 5, on the side from which driving force is transmitted to the toner supply container 5, that is, on the back side (right side in FIG. 5) in terms of the toner supply container insertion direction.

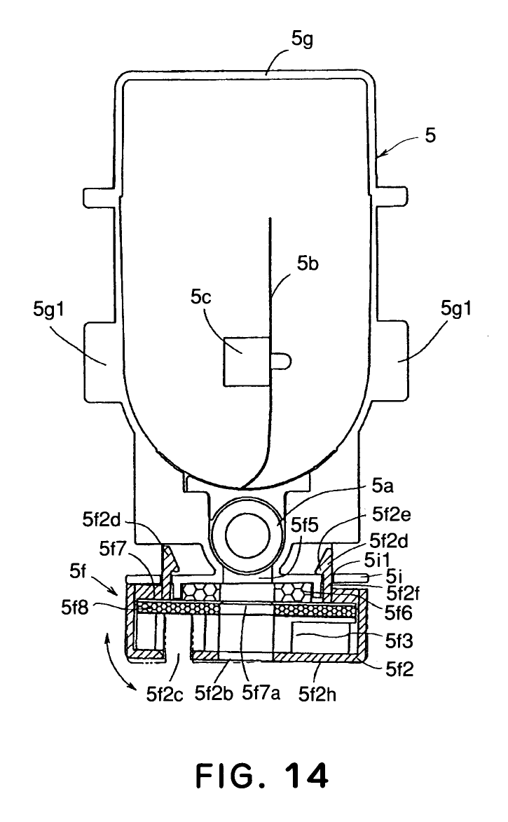

At this time, referring to FIG. 14, the structures of the adjacencies of the first hole 5f5 will be described in detail. FIG. 14 is a vertical sectional view of the toner supply container 5, at a plane which is perpendicular to the lengthwise direction of the toner supply container 5 and includes the axis of the first hole 5f5 of the toner outlet 5f. The first hole 5f5, which is a through hole, is directly below the screw 5a, and the first sealing member 5f6 is attached to the bottom wall of the frame 5g of the toner supply container 5, surrounding the bottom edge of the first hole 5f5.

The first sealing member 5f6 is provided to prevent toner from leaking from the interface between the toner supply container 5 and toner outlet 5f. It is an elastic member with a certain amount of thickness and has a hole which is the same in cross section and size as the first hole 5f5. It is held to the toner supply container 5 by being pasted to the bottom edge portion of the first hole 5f5, by its top surface. The material for the first sealing member 5f6 in this embodiment is foamed urethane. However, it does not need to be limited to foamed urethane; it may be any elastic material.

There is a sealing plate 5f7 on the bottom side of the first sealing member 5f6. More specifically, the sealing plate 5f7 is pasted to the bottom surface of the first sealing member 5f6 by its top surface, being thereby held to the first sealing member 5f6. Thus, the sealing plate 5f7 is allowed to move vertically, and/or tilt, as the first sealing member 5f6 is compressed or decompressed. The sealing plate 5f7 is provided with a hole, that is, the third hole 5f7a of the toner outlet 5f, which is a through hole, and aligns with the first hole 5f5. Thus, the toner in the toner supply container 5 falls through the first hole 5f5, the hole of the first sealing member 5f6, and the third hole 5f7a of the sealing plate 5f7, in this order.

The toner supply container 5 is also provided with the toner outlet shutter 5f3 for sealing or unsealing the first hole 5f5. The toner outlet shutter 5f3 is attached to the bottom wall of the frame 5g of the toner supply container 5. Further, the toner supply container 5 is provided with the retaining member 5f2, which has the function of preventing the toner outlet shutter 5f3 from falling down, and the function of connecting the toner outlet 5f of the toner supply container 5 with the toner inlet 1b of the process cartridge 1, and which is attached to the bottom of the toner supply container 5.

Referring to FIG. 14, the toner outlet shutter 5f3 is below the sealing plate 5f7, with the second sealing member 5f8 sandwiched between the toner outlet shutter 5f3 and sealing plate 5f7.

The second sealing member 5f8 is for preventing the toner from leaking from the joint between the hole (second hole 5f3b of toner outlet) of the toner outlet shutter 5f3 and the hole (third hole of toner outlet) of the sealing plate 5f7. It is an elastic member having a hole, which aligns with the second hole 5f3b. It is solidly pasted to the toner outlet shutter 5f3, by its bottom surface. However, the top surface of the second sealing member 5f8 is not solidly attached to the bottom surface of the sealing plate 5f7, allowing the second sealing member 5f8 to slide on the bottom surface of the sealing plate 5f7. As for the material for the second sealing member 5f8, an elastic substance which is low in the friction against the sealing plate 5f7, is preferable. For example, foamed urethane, a combination of a piece of foamed urethane and low friction sheet pasted to the surface of foamed urethane, etc., can be used.

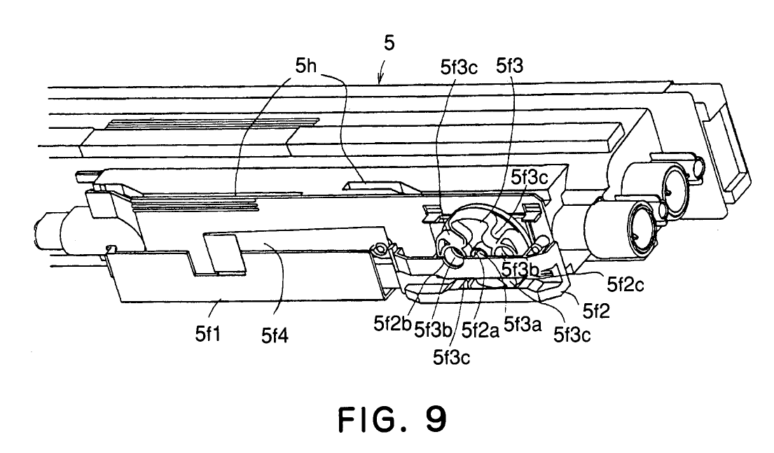

FIG. 9 is an enlarged perspective view of the bottom back end side of the toner supply container 5, the toner outlet cover 5f1 and toner outlet shutter 5f3 of which are in the open positions. In the drawing, the right half of the toner outlet cover 5f1, as seen from the trailing side of the toner supply container 5 in terms of the toner supply container insertion direction, has been removed in order to make it easier to understand the structure of the toner outlet and its adjacencies. As will be evident from FIG. 9, the toner outlet shutter 5f3 is provided with the center hole 5f3a, about the axial line of which the toner outlet shutter 5f3 is rotated. The toner outlet shutter 5f3 is also provided with two holes (second hole 5f3b of toner outlet) symmetrically positioned with respect to the axial line of the center hole 5f3a, and four slots, which are 45° apart from the adjacent second hole 5f3b in terms of rotational phase of the toner outlet shutter 5f3, and in which the projections of the process cartridge 1 fit to rotate the toner outlet shutter 5f3.

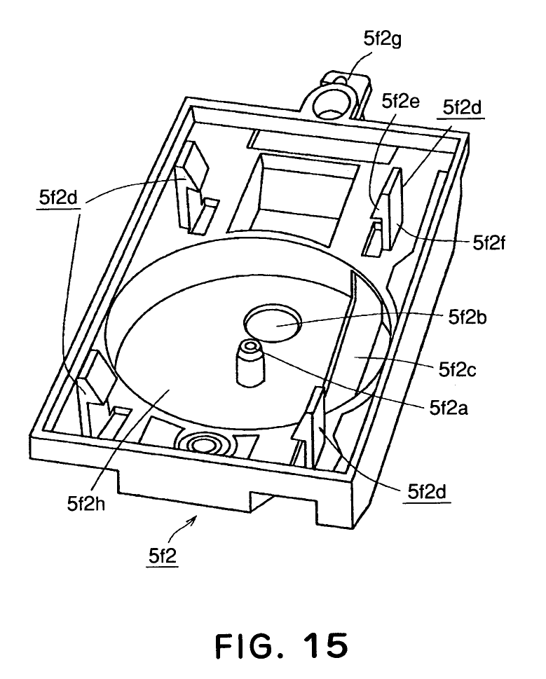

Next, referring to FIG. 15, the retaining member 5f2 will be described. FIG. 15 is a perspective view of the retaining member 5f2 which has been removed from the toner supply container 5. The retaining member 5f2 is provided with a pin 5f2a with which the retaining member 5f2 rotationally supports the toner outlet shutter 5f3 so that the toner outlet shutter 5f3 rotates about the pin 5f2a, and a through hole (fourth hole of toner outlet) 5f2b through which the toner is supplied, and an elongated hole 5f2c which extends practically straight in the lengthwise direction of the retaining member 5f2.

The pin 5f2a is perpendicular to the bottom wall 5f2h of the retaining member 5f2. As the toner outlet shutter 5f3 is placed in the retaining member 5f2 so that the pin 5f2a fits into the center hole 5f3a of the toner outlet shutter 5f3, the toner outlet shutter 5f3 is rotatably supported by the retaining member 5f2.

The retaining member 5f2 is provided with four hooks 5f2d, which project upward from the four corner portions of the retaining member 5f2. Referring to FIG. 14, as the retaining member 5f2 is pressed onto the bottom wall 5i of the frame 5g of the toner supply container 5, with the four hooks 5f2d of the retaining member 5f2 aligned with the four holes 5i1 of the bottom wall 5i, one for one, the four hooks 5f2d fit into the corresponding holes 5i1, and the claw 5f2e of each hook 5f2d latches onto the bottom wall 5i, holding the retaining member 5f2 to the toner supply container 5 as if the retaining member 5f2 is suspended from the bottom wall 5i of the toner supply container 5.

The stem portion 5f2f of each hook 5f2d is made slightly longer than the exact length necessary to attach the retaining member 5f2 to the toner supply container 5. Therefore, the claw 5f2e of each hook 5f2d is kept downwardly pressed on the bottom wall 5i by the resiliency of the first sealing member 5f6, holding thereby the retaining member 5f2 as if the retaining member 5f2 is hanging from the bottom wall 5i. Further, each hook 5f2d fits in the corresponding hole 5i1, with the presence of a gap between the hook 5f2d and the wall of the hole 5i1, in terms of the horizontal direction, allowing the retaining member 5f2 to move left or right, or tilt, relative to the bottom wall 5i.

In other words, the retaining member 5f2 is held to the bottom wall 5i of the toner supply container 5, with the presence of a small mount of play, so that the retaining member 5f2 is allowed to move up and down, or tilt, relative to the frame 5g (FIG. 14). This tilting of the retaining member 5f2 is not limited to the left- and rightward directions, indicated by arrow marks; the retaining member 5f2b is allowed to tilt also in the backward or frontward direction.

It should be noted here that the retaining member 5f2, toner outlet shutter 5f3, and sealing plate 5f7 are allowed to move together up and down, left or right, or tilt, relative to the frame 5g.

The toner outlet cover 5f1 is held to the toner supply container 5 by the rails 5h and 5h′ of the toner supply container 5, covering the retaining member 5f2, so that the toner outlet shutter 5f3 is allowed to move toward the trailing side in terms of the toner supply container insertion direction, relative to the process cartridge 1, and then, retract upward.

Prior to the mounting of the toner supply container 5 into the image forming apparatus 100, the hole (second hole 5f3b) of the toner outlet shutter 5f3 is in the first position which is deviated by 90° in rotational phase from the first hole 5f5 of toner outlet. Therefore, the first hole 5f5 is blocked by the toner outlet shutter 5f3.

The retaining member 5f2 is provided with another hook 5f2g for anchoring one end of the tension spring 67 to the retaining member 5f2, so that the toner outlet cover 5f1 is kept in the first position, in which the toner outlet cover 5f1 covers the retaining member 5f2, by the tension spring 67 (FIG. 6), while remaining under the pressure from the tension spring 67.

Next, the sequence which occurs when the toner supply container 5 is inserted into, or extracted from, the image forming apparatus 100 will be described.

As described before with reference to FIG. 8, the image forming apparatus 100 is provided with the projection 68, which is projecting in the toner supply container insertion path. Thus, as the toner supply container 5 is inserted into the image forming apparatus 100, the leading end of the toner outlet cover 5f1 comes into contact with this projection 68. Then, as the toner supply container 5 is inserted deeper against the resiliency of the tension coil spring 67, the toner outlet cover 5f1 is kept stationary by the projection 68, while appearing as if it were moved backward relative to the main assembly of the toner supply container 5 along the rails 5h and 5h′ of the toner supply container 5. Then, as the toner supply container 5 is inserted more deeply, the toner outlet cover 5f1 retracts upward by being guided by the rails 5h and 5h′.

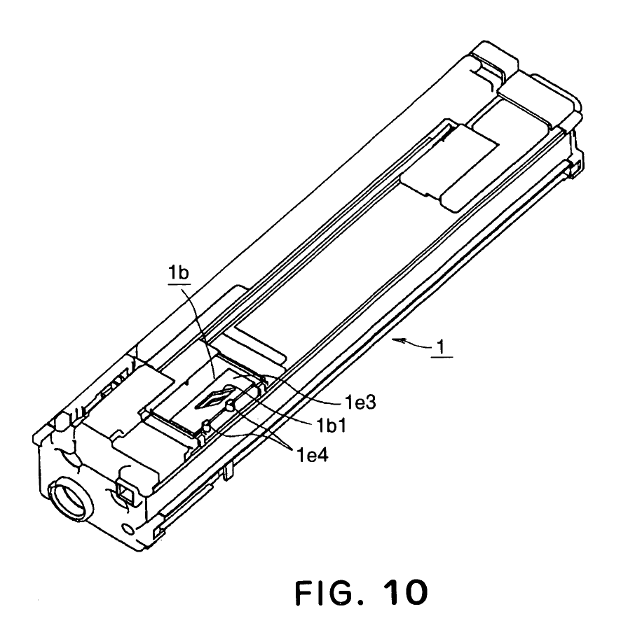

FIG. 10 is a perspective view of the process cartridge 1 in this embodiment as seen from the top front side. The toner inlet 1b through which the toner is supplied into the process cartridge 1 from the toner supply container 5 is provided with a tone entrance hole 1b1.

The toner entrance hole 1b1 is a through hole as the passage through which the toner from the toner supply container 5 free falls. The toner inlet 1b is provided with a sealing member 1e3 for preventing the toner from leaking from the joint between the toner entrance hole 1b1 of the process cartridge 1 and the hole of the toner outlet 5f of the toner supply container 5. The sealing member 1e3 is formed of an elastic material, and has a hole which is the same in shape and size as the toner entrance hole 1b1.

The process cartridge 1 is also provided with a pair of guiding pins 1e4 for rotating the toner outlet shutter 5f3 of the toner supply container 5. The pair of guiding pins 1e4 are positioned next to the edge of the sealing member 1e3, being aligned in parallel to the lengthwise direction of the process cartridge 1.

The toner entrance hole 1b1 is a roughly parallelepipedic through hole, one of the two pairs of opposing edges of which are parallel to the lengthwise direction of the process cartridge 1. The aforementioned sealing member 1e3 is disposed in a manner to surround the toner entrance hole 1b1.

The sealing member 1e3 is for keeping sealed the interface (joint) between the retaining member 5f2 of the toner supply container 5 and the toner inlet 1b of the process cartridge 1. Not only is the sealing member 1e3 desired to have elasticity, but also it is desired to be highly effective for wiping toner away and low in friction. Thus, Teflon (registered commercial name) felt, Teflon pile, or the like felt or pile produced by electrostatic planting, foamed urethane, etc., for example, can be used as the material for the sealing member 1e3.

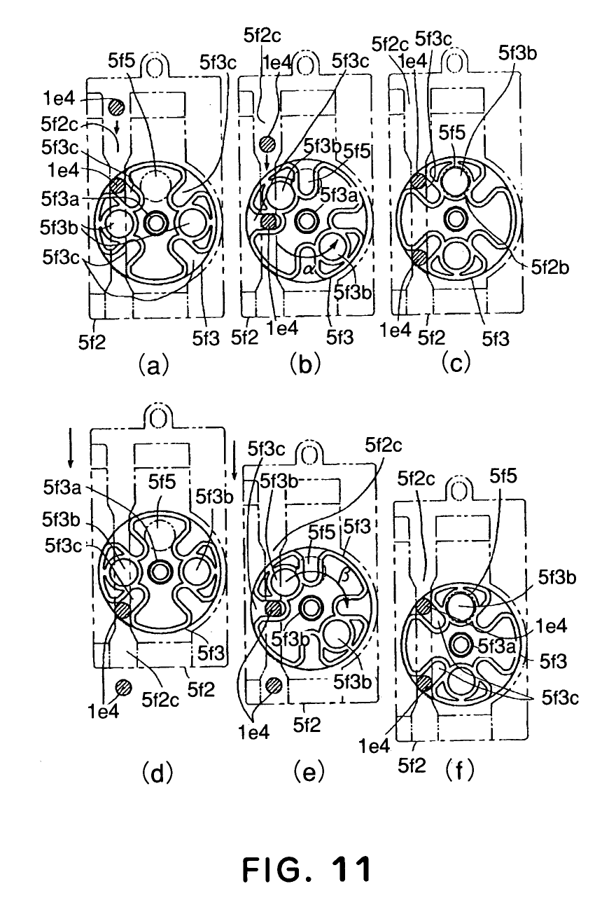

FIG. 11 is a drawing for showing the movement of the toner outlet shutter 5f3. FIGS. 11(a)-11(c) show the movements of the toner outlet shutter 5f3 which occur when the process cartridge 1 is inserted into the image forming apparatus 100 in which the toner supply container 5 is already present. FIGS. 11(d)-11(f) show the movements of the toner outlet shutter 5f3 which occur when the toner supply container 5 is inserted into the image forming apparatus 100 in which the process cartridge 1 is already present.

Referring to FIGS. 11(d)-11(f), when the toner supply container 5 is inserted into the image forming apparatus 100 in which the process cartridge 1 is already present, the guiding pins 1e4 do not move.

As the toner supply container 5 is inserted in the direction indicated by an arrow mark, the guiding pin 1e4 of the process cartridge 1, on the front side of the image forming apparatus 100, fits into the slot 5f3c of the toner outlet shutter 5f3 (FIG. 11(c)). In this state, the first hole 5f5 remains closed by the toner outlet shutter 5f3 because the second hole 5f3b is apart from the first hole 5f5 by 90° in terms of rotational direction.

As the toner supply container 5 is inserted deeper, the toner outlet shutter 5f3 begins to be rotated about the axial line of the center hole 5f3a of the toner outlet shutter 5f3 in the direction indicated by an arrow mark β (FIG. 11(e)), and continues to be rotated until the toner supply container 5 is completely inserted. Consequently, the toner outlet shutter 5f3 is rotated into the position shown in FIG. 11(f), in which the first hole 5f5, that is, the hole of the bottom wall 5i of the frame 5g of the toner supply container 5 aligns with the second hole 5f3b, that is, the hole of the toner outlet shutter 5f3, allowing the toner to be discharged.

Next, referring to FIGS. 11(a)-11(c), when the process cartridge 1 is inserted into the image forming apparatus 100 in which the toner supply container 5 is already present, the toner outlet shutter 5f3 is rotated without being changed in its position relative to the image forming apparatus 100.

As the process cartridge 1 is inserted in the direction indicated by an arrow mark, the guiding pin 1e4, on the back side of the image forming apparatus 100, fits into the slot 5f3c of the toner outlet shutter 5f3 (FIG. 11(a)). In this state, the first hole 5f5 remains closed by the toner outlet shutter 5f3 because the second hole 5f3b is apart from the first hole 5f5 by 90° in terms of rotational direction.

As the process cartridge 1 is inserted deeper, the toner outlet shutter 5f3 begins to be rotated about the axial line of the center hole 5f3a of the toner outlet shutter 5f3 in the direction indicated by an arrow mark a (FIG. 11(b)), and continues to be rotated until the process cartridge 1 is completely inserted. Consequently, the toner outlet shutter 5f3 is rotated into the position shown in FIG. 11(c), in which the first hole 5f5, that is, the hole of the bottom wall 5i of the frame 5g of the toner supply container 5 aligns with the second hole 5f3b, that is, the hole of the toner outlet shutter 5f3, allowing the toner to be discharged.

Incidentally, when the toner outlet shutter 5f3 is in the state shown in FIGS. 11(c) and 11(f), the first hole 5f5, that is, the hole of the bottom wall of the frame 5g of the toner supply container 5, is aligned with the toner entrance hole 1b1 of the process cartridge 1, which is needless to say.

As described above, the retaining member 5f2 is attached to the bottom wall 5i of the frame 5g of the toner supply container 5 so that the retaining member 5f2 is allowed to slightly move up or down, or slightly tilt, relative to the bottom wall 5i. Therefore, as the toner supply container 5 or process cartridge 1 is inserted into the image forming apparatus 100, the retaining member 5f2 conforms to the shape of the sealing member 1e3 of the process cartridge 1 (FIG. 10), remaining thereby airtightly in contact with the sealing member 1e3. Therefore, the toner does not scatter from the container when the toner supply container 5 or process cartridge 1 is inserted into the image forming apparatus 100.

If the toner outlet shutter 5f3 alone is structured to prevent the toner from leaking from the toner outlet 5f, it is impossible to completely prevent the toner leak; it is virtually impossible to completely prevent the toner adhering to the internal surface of the second hole 5f3b, that is, the hole of the toner outlet shutter 5f3, from leaking. On the other hand, if the toner outlet cover 5f1 alone is structured to prevent the toner leak, it is possible that the toner will leak, because there is a possibility that a user might accidentally move the toner outlet cover 5f1 into the open position.

In this embodiment, however, both the toner outlet shutter 5f3 and toner outlet cover 5f1 are provided with the toner leak prevention structure, as described above. In other words, the toner leak prevention means is duplexed, assuring that the toner does not leak; the toner adhering to the internal surface of the second hole 5f3b is prevented by the toner outlet cover 5f1 from leaking out. Further, the slots 5f3c of the toner outlet shutter 5f3 for rotationally driving the toner outlet shutter 5f3 remain covered with the toner outlet cover 5f1, eliminating the possibility that the toner outlet 5f will be accidentally exposed.

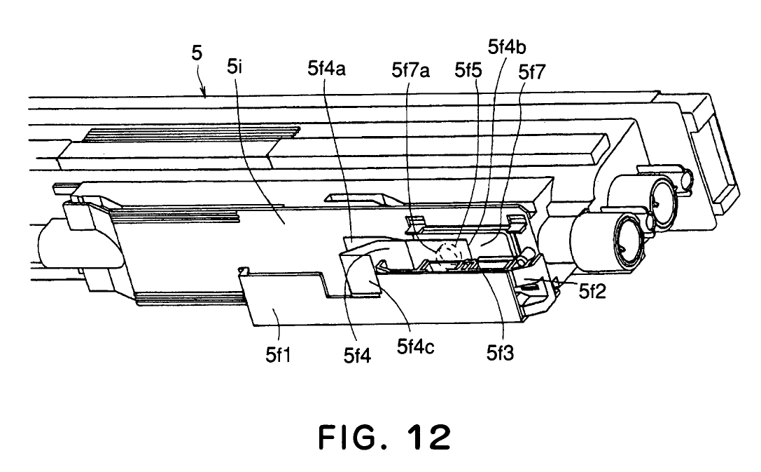

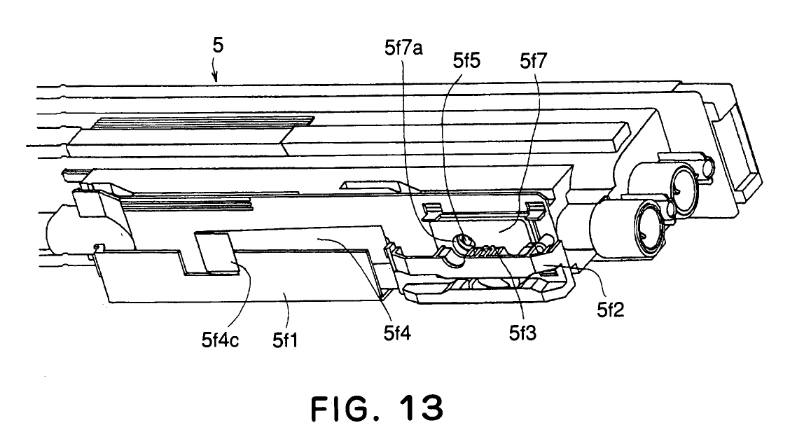

FIG. 12 is an enlarged perspective view of the back end portion of the brand-new toner supply container 5 in this embodiment, the toner outlet shutter 5f3 and toner outlet cover 5f1 of which are closed, as seen from the back bottom end of the container 5, and FIG. 13 is an enlarged perspective view of the back end portion of the brand-new toner supply container 5 in this embodiment, the toner outlet shutter 5f3 and toner outlet cover 5f1 of which are open. In both drawings, the right halves of the toner outlet cover 5f1, retaining member 5f2, and toner outlet shutter 5f3, as seen from the trailing side of the toner supply container 5 in terms of the toner supply container insertion direction, have been removed in order to make it easier to understand their structures.

Referring to FIG. 12, when the toner supply container 5 is brand-new, the toner outlet cover 5f1 and toner outlet shutter 5f3 are closed, and the first hole 5f5, that is, the hole of the bottom wall 5i of the frame 5g of the toner supply container 5, is surrounded by the sealing member 5f6 covered with the sealing plate 5f7 glued to the sealing member 5f6.

The hole of the sealing member 5f7, that is, the third hole 5f7a, is sealed with a flexible and peelable tape 5f4.

The tape 5f4 is positioned between the sealing plate 5f7 and sealing member 5f8 (FIG. 14). It is attached to the toner supply container 5 in the following manner: the tap 5f4 is fixed to the bottom wall 5i of the frame 5g of the toner supply container 5, by one end 5f4a; extended toward the back end of the toner supply container 5, far enough to cover the third hole 5f7a; peelably glued or welded to the edge of the third hole 5f7a, sealing thereby the third hole 5f7a; folded back at the folding line 5f4b; doubled back over the portion of the tape 5f4 which is sealing the third hole 5f7a; and fixed to the toner outlet cover 5f1 by the other end 5f4c.

As described above, as the toner supply container 5 is inserted into the image forming apparatus 100, the toner outlet cover 5f1 is moved relative to the toner supply container 5 along the rails 5h and 5h′, in the direction to expose the toner outlet 5f. Thus, the tap 5f4 is peeled from the bottom wall 5i, starting from the folding line 5f4, exposing the third hole 5f7a. Incidentally, once the tape 5f4 is peeled, it does not return into the interface between the sealing plate 5f7 and sealing member 5f8, even if the toner outlet cover 5f1 is returned to the closed position.

With the employment of the above described structural arrangement, the third hole 5f7a remains sealed with the tape 5f4 from the completion of the production of the toner supply container 5 until the toner supply container 5 is inserted into the image forming apparatus 100 by a user or a service person after being obtained by the user through a distribution network. Therefore, the toner does not leak out even if the toner supply container 5 is subjected to shocks or excessive vibrations.

In this structural arrangement, the tape 5f4 is automatically peeled by the insertion alone of the toner supply container 5 into the image forming apparatus 10. Therefore, the employment of the tape 5f4 does not adversely affect the operability of the toner supply container 5. Further, the movement of the toner outlet cover 5f1 is regulated by the rails 5h and 5h′. Therefore, the problem that the tape 5f4 is pulled in an unexpected direction as the toner outlet cover 5f1 is moved relative to the toner supply container 5 does not occur. Therefore, the problem that the portions of the toner supply container 5 in the adjacencies of the tape 5f4 are damaged by the pulling of the tape 5f4 in the unexpected direction, and/or the problem that the force necessary to peel the tape 5f4 increases due to the pulling of the tape 5f4 in the unexpected direction, does not occur.

During the manufacture of the toner supply container 5, toner is poured into the toner supply container 5 through the toner entrance hole 5k of the toner supply container 5, as shown in FIG. 5. After the filling of the toner supply container 5 with toner, the toner entrance hole 5k is plugged with a toner entrance cap 80 to prevent the filled toner from leaking.

Also in this embodiment, the toner supply container 5 is provided with a handle 81, which is attached to the toner supply container 5 in a manner to cover the toner entrance cap 80. Therefore, a user is to handle the toner supply container 5 by the grip portion 81a of the handle 81.

[Transferring Means]

The intermediary transfer unit 54, as a transferring means, in FIG. 1 is a unit for transferring (secondary transfer) all at once onto the recording medium 52 a plurality of toner images having been sequentially transferred in layers onto the intermediary transfer unit 54 from the photoconductive drum 2.

The intermediary transferring unit 54 is provided with an intermediary transfer belt 54a, which runs in the direction indicated by an arrow mark at virtually the same peripheral velocity as that of the photoconductive drum 2 which rotates in the clockwise direction indicated by another arrow mark. The intermediary transfer belt 54a is an endless belt with a circumferential length of approximately 970 mm, and is suspended around three rollers: a driver roller 54b, a belt backing transfer roller 54g, and a follower roller 54c.

Within the loop of the intermediary transfer belt 54a, transfer charge rollers 54fY, 54fM, 54fC, and 54fK are rotatably disposed, opposing the corresponding photoconductive drums 2 with the presence of the intermediary transfer belt 54a between the transfer charge rollers 54fY, 54fM, 54fC, and 54fK and the corresponding photoconductive drums 1. Each transfer charge roller is kept pressured toward the center of the corresponding photoconductive drum 2.

The transfer charge rollers 54fY, 54fM, 54fC, and 54fK are supplied with power by an unshown high voltage power source, and charge the intermediary transfer belt 54a to the polarity opposite to that of the toner, from the inward side of the loop of the intermediary transfer belt 54a, in order to sequentially transfer (primary transfer) the toner images on the photoconductive drum 2 onto the outward surface of the intermediary transfer belt 54a.

During transfer, the secondary transfer roller 54d as a transferring member is kept pressed on the intermediary transfer belt 54a, opposing the belt backing transfer roller 54g with the presence of the intermediary transfer belt 54a between the secondary transfer roller 54d and belt backing transfer roller 54g. The secondary transfer roller 54d is movable in the vertical direction in FIG. 1, and is rotatable. Until a predetermined number of images are sequentially transferred in layers onto the intermediary transfer belt 54a to complete a multicolor image, the secondary transfer roller 54d is kept apart from the intermediary transfer belt 54a in order not to disturb the images on the intermediary transfer belt 54a.

The intermediary transfer belt 54a and secondary transfer roller 54d are individually driven. As the recording medium 52 is entered into the secondary transfer portion, a predetermined bias is applied to the secondary transfer roller 54d. As a result, the toner images on the intermediary transfer belt 54a are transferred (secondary transfer) onto the recording medium 52.

During the transfer process, the recording medium 52 is conveyed leftward of FIG. 1 at a predetermined velocity, while remaining sandwiched between the secondary transfer roller 54d and intermediary transfer belt 54a, to a fixing device 56 which carries out the next process.

The image forming apparatus 100 is provided with a cleaning unit 55, which can be placed in contact with, or moved away from, the surface of the intermediary transfer belt 54a, and which is at a predetermined location in the adjacencies of the downstream end of the intermediary transfer belt 54a in terms of the direction in which the recording medium is conveyed during the transfer process. The cleaning unit 55 removes the secondary transfer residual toner, that is, the toner remaining on the intermediary transfer belt 54a after the secondary transfer.

Referring again to FIG. 1, within the cleaning unit 55, a cleaning blade 55a for removing the secondary transfer residual toner is disposed. The cleaning unit 55 is attached to the main assembly of the image forming apparatus 100 so that it can be pivoted about an unshown pivotal axis. The cleaning blade 55a is kept pressed on the intermediary transfer belt 54a, being tilted so that the cleaning edge of the cleaning blade 55a is on the upstream side relative to the base portion of the cleaning blade 55a in terms of the moving direction of the intermediary transfer belt 54a. After being taken into the cleaning unit 55, the secondary transfer residual toner is conveyed by a screw 55b to a removed toner bin (unshown) and is stored therein.

As for the material for the intermediary transfer belt 54a, polyimide resin is usable. However, the material for the intermediary transfer belt 54a does not need to be limited to polyimide resin. For example, such plastics as polycarbonate resin, polyethylene-terephthalate resin, polyvinylidene fluoride resin, polyethylene naphthalate resin, polyether-ether-ketone resin, and polyether sulfonate resin, or fluorinated or siliconized rubber, can be used with preferable results.

[Fixing Portion]

As described above, a toner image formed on the photoconductive drum 2 by the developing means is transferred onto the recording medium 52 by way of intermediary transfer belt 54a. The fixing device 56 thermally fixes the unfixed toner images, that is, the images having just been transferred onto the recording medium 52.

Also referring to FIG. 1, the fixing device 56 is provided with a fixing roller 56a for applying heat to the recording medium 52, and a pressure roller 56b for pressing the recording medium 52 against the fixing roller 56a. Both rollers 56a and 56b are hollow. Each roller contains a heater (unshown) in its hollow. They together convey the recording medium 52 as they are rotationally driven.

In other words, while the recording medium 52, which is bearing toner images, is conveyed by the fixing roller 56a and pressure roller 56b, heat and pressure are applied to the recording medium 52 and toner images by the rollers. As a result, the toner images are fixed to the recording medium 52.

After the fixation, recording medium 52 is discharged out of the main assembly of the image forming apparatus 100 by two pairs 53h and 53j of discharge rollers, into a delivery tray 57 on top of the image forming apparatus 100, and is accumulated therein.

[Mounting of Process Cartridge and Toner Supply Container]

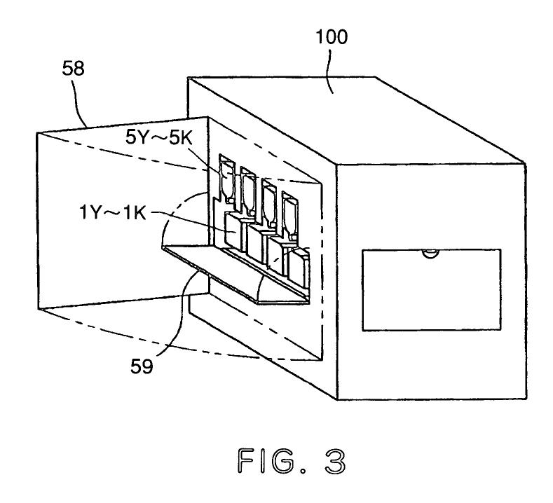

Next, referring to FIGS. 2-5, the procedure for mounting the process cartridge 1 and toner supply container 5 into the image forming apparatus 100 will be described. Referring to FIG. 3, which is a schematic external perspective view of the image forming apparatus 100, the image forming apparatus 100 is provided with a door (front door) 58, which is located in the front panel of the image forming apparatus 100 and can be freely opened or closed. As an operator opens the door 27 frontward, the openings through which the process cartridges 1Y-1K, and toner supply containers 5Y-5K, are inserted, are exposed.

The openings through which the process cartridge 1 is inserted are provided with the drum shaft positioning plate 59, which is rotatably supported. Thus, when inserting or removing the process cartridge 1, this drum shaft positioning plate 59 must be opened and closed. Referring to FIG. 2, in the image forming apparatus 100, four pairs of guiding rails 60 for guiding the process cartridge 1 when mounting the process cartridge 1, and four pair of guiding rails 61 for guiding the toner supply container 5 when mounting the toner supply container 5, are provided.

The directions in which the process cartridge 1 and toner supply container 5 are mounted into the image forming apparatus 100 are parallel to the axial line of the photoconductive drum 2, and so are the directions in which the guiding rails 60 and 61 extend. The process cartridge 1 and toner supply container 5 are inserted into the image forming apparatus 100, from the front side of the image forming apparatus 100, and then, are slid deeper into the image forming apparatus 100 along the guiding rails 60 and 61.

Referring to FIG. 4, as the process cartridge 1 reaches the deepest end of the image forming apparatus 100, the drum positioning shaft 66 of the image forming apparatus 100 enters the center hole 2f of the drum flange 2b. As a result, the rotational axis of the back end of the photoconductive drum 2 is accurately positioned relative to the image forming apparatus 100.

At the same time, the driving force transmitting portion 2g of the drum flange 2b engages with the driving coupling (female coupling) 62a of the image forming apparatus 100, making it possible for the photoconductive drum 2 to be rotationally driven. The driving force transmitting portion 2g in this embodiment is in the form of a twisted triangular column. Thus, as driving force is transmitted to the driving force transmitting portion 2g from the image forming apparatus 100, not only does the driving force transmitting portion 2g transmits the driving force to the photoconductive drum 2, but also generates such force that pulls the photoconductive drum 2 toward the back end of the image forming apparatus 100.

Also referring to FIG. 4, the rear wall 65 of the image forming apparatus 100 is provided with four cartridge supporting pins 63 for accurately positioning the process cartridges 1, one for one. Each cartridge supporting portion 63 enters the frame 1a of the inserted process cartridge 1, whereby the frame 1a of the process cartridge 1 is accurately fixed in its position relative to the image forming apparatus 100.

Referring again to FIG. 4, on the front side (left side in FIG. 4) of the image forming apparatus 100, the drum shaft positioning plate 59, which is rotationally opened or closed, is disposed, and with which the bearing case 2c of the process cartridge 1 is solidly engaged. Through the above described process cartridge insertion sequence, the photoconductive drum 2 and process cartridge 1 are accurately positioned relative to the image forming apparatus 100.

In comparison, referring to FIG. 5, as the toner supply container 5 is inserted to the deepest end, it is solidly held by the supporting pin 64 projecting from the rear wall 65 of the image forming apparatus 100 as is the process cartridge 1 by the supporting pin 64. At the same time, the driving force receiving coupling (female) 5e engages with the driving force transmitting coupling (male) 62b, making it possible to rotationally drive the screw 5a and stirring shaft 5c.

All that is necessary to extract the process cartridge 1 or toner supply container 5 from the image forming apparatus 100 is to carry out the above described procedures in reverse. In this embodiment, the process cartridge 1 and toner supply container 5 can be mounted into, or removed from, the image forming apparatus 100 in random order.

In other words, it is possible to mount the toner supply container 5 into the image forming apparatus 100 after mounting the process cartridge 1 into the image forming apparatus 100, or to mount the process cartridge 1 into the image forming apparatus 100 after mounting the toner supply container 5 into the image forming apparatus 100.

Further, it is possible to extract the toner supply container 5 from the image forming apparatus 100 after extracting the process cartridge 1 from the image forming apparatus 100, or to extract the process cartridge 1 from the image forming apparatus 100 after extracting the toner supply container 5 from the image forming apparatus 100.

[Method for Refilling Toner Supply Container with Toner]

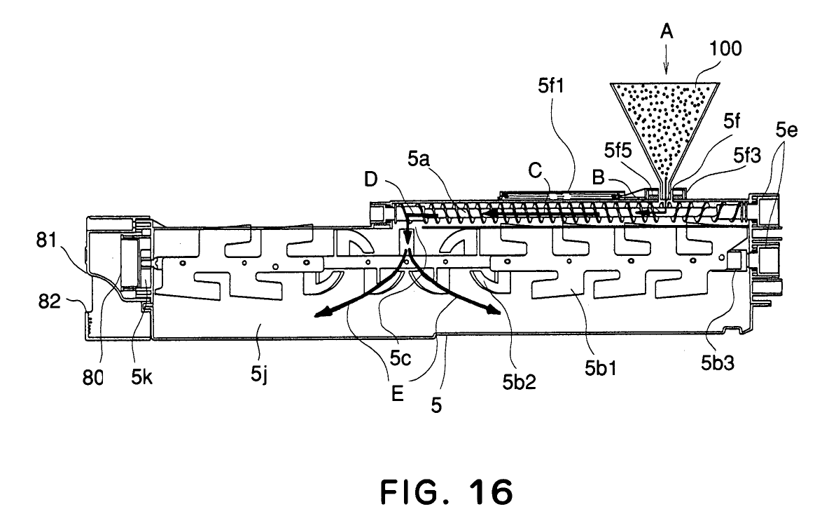

FIG. 16 shows a method for refilling the used toner supply container 5 with toner, in other words, a method for remanufacturing the used toner supply container 5 by refilling it with toner.

First, the toner outlet cover 5f1 is to be slid. Then, the toner outlet shutter 5f3 of the toner supply container 5 is to be rotated to expose the opening of the toner outlet 5f, through which the toner is discharged (toner outlet exposing process).

Next, the toner supply container 5 is to be secured so that the toner outlet 5f of the toner supply container 5 faces upward. Then, toner is to be filled into the toner supply container 5 through the toner outlet 5f by inserting a toner refilling jig 200 as a member for guiding toner to the first hole 5f5 as indicated by an arrow mark A in FIG. 16 (filling process).

During this filling of toner, the screw 5a, as a toner conveying member, in the toner supply container 5 is rotated in the direction opposite to the direction in which the screw 5a is rotated to convey the toner to the developing apparatus 4, so that the filled toner is sent deeper into the toner supply container 5, as indicated by arrow marks B, C, and D (driving process). In other words, the screw 5a is driven to convey the toner from the toner outlet 5f to the toner storage portion 5j. The toner is conveyed first in the direction indicated by the arrow mark C, parallel to the axial direction of the screw 5, and then, in the direction indicated by the arrow mark D.

Incidentally, it does not matter which process is started first, the filling process or driving process. In other words, the driving force may be transmitted to the screw 5 after the pouring of toner into the toner supply container 5 through the hole 5f5, or toner may be poured into the toner supply container 5 through the hole 5f5 after starting to transmit the driving force to the screw 5a. Further, the transmission of driving force to the screw 5a may be started at the same time as the pouring of toner into the hole 5f5 is started.

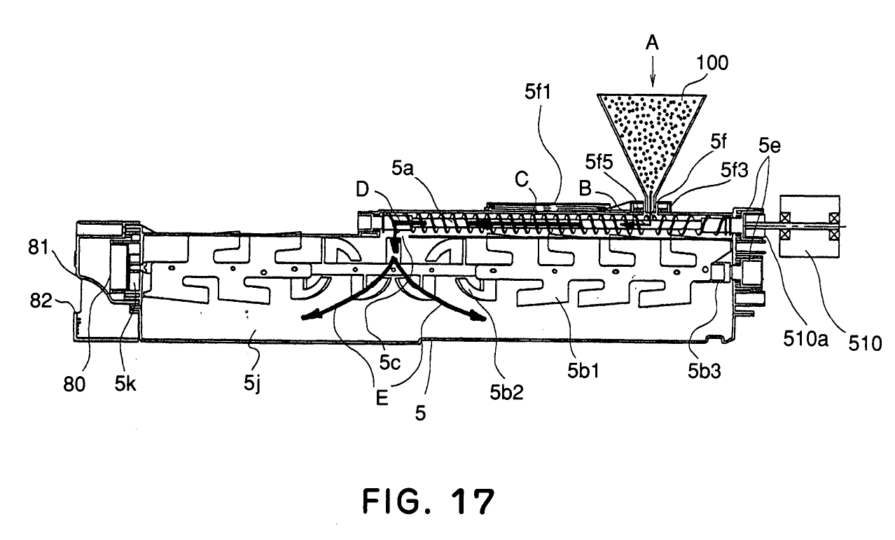

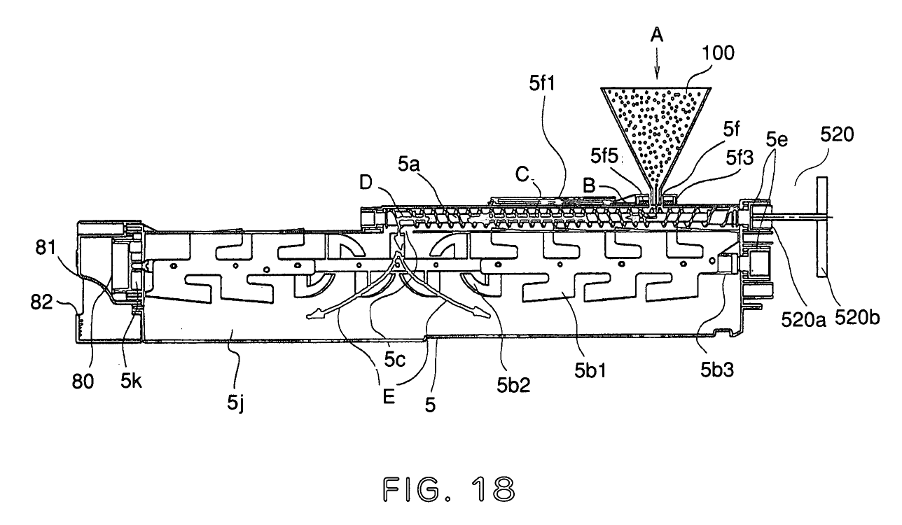

The screw 5a is driven by transmitting driving force to the driving force receiving coupling 5e. There are two methods for providing the screw 5a with driving force: a method which employs a driving force generating apparatus 510 shown in FIG. 17, and a manual method which employs a rotational force transmitting member 520 shown in FIG. 18.

In the method which employs the driving force generating apparatus 510 to provide the screw 5 with driving force, the coupling 510a of the driving force generating apparatus 510 is connected with the driving force receiving coupling 5e, as shown in FIG. 17, and driving force is transmitted from the driving force generating apparatus 510 to the driving force receiving coupling 5e so that the screw 5a will convey toner in the direction indicated by the arrow mark C. In other words, the driving force receiving coupling 5e is rotated in the direction opposite to the direction in which it is rotated when toner is supplied to the process cartridge 1.

In the manual method which employs the rotational force transmitting member 520, the coupling 520s of the rotational force transmitting member 520 is connected to the driving force receiving coupling 5e as shown in FIG. 18, and the rotational force transmitting member 520 is manually rotated by a knob 10b to transmit driving force to the coupling 5e so that the screw 5a conveys toner in the direction indicated by the arrow mark C.

As described above, the toner supply container 5 can be refilled with toner simply by pouring toner through the toner outlet 5f in the direction opposite to the direction in which toner is discharged when the toner supply container 5 is in use. Therefore, the toner supply container 5 can be simply remanufactured.

Also as described above, the toner outlet 5f of the toner supply container 5 is provided with the movable toner outlet cover 5f1 for covering the toner outlet 5f. Therefore, the toner supply container 5 can be refilled with toner by opening this toner outlet cover 5f1, and the refilled toner can prevented from leaking, by closing the toner outlet cover 5f1 after the refilling (toner outlet closing process). Thus, the toner supply container 5 can be refilled a substantial number of times.

Incidentally, in a toner supply container refilling method in which the toner cap 80 is removed to refill the toner supply container 5 with toner through the toner filling hole 5k, there is a possibility that the toner cap 80 will be damaged when it is removed. Obviously, a damaged toner cap 80 is not reusable. In comparison, in this embodiment, the toner cap 80 is not removed when refilling the toner supply container 5 with toner. Therefore, it is assured that the toner cap 80 is reused; in other words, the entirety of the toner supply container 5 can be reused, without any damage to its components.

As described above, in this embodiment, the toner supply container 5 is structured so that it can be refilled with toner simply by pouring toner through the toner outlet in the direction opposite to the direction in which toner flows when it is in use. Therefore, virtually the entirety of the toner supply container 5 can be reused. In addition, component removal is unnecessary, eliminating component damage, and therefore, assuring that all the components can be reused In other words, the toner supply container 5 in accordance with the present invention can be reused in entirety for its remanufacure.

While the invention has been described with reference to the structures disclosed herein, it is not confined to the details set forth, and this application is intended to cover such modifications or changes as may come within the purposes of the improvements or the scope of the following claims.

What is claimed is:

1. A recycling method for a developer supply unit for supplying a developer to developing means for developing an electrostatic latent image formed on an electrophotographic photosensitive member, wherein said developer supply unit is detachably mountable to a main assembly of an electrophotographic image forming apparatus and includes a developer accommodating portion for accommodating the developer, a developer supply port for supplying the developer to said developing means and a feeding member for feeding the developer to the developer supply port from the developer accommodating portion, said method comprising:
an injection step of injecting the developer through the developer supply port; and
driving step of driving the feeding member in a direction for feeding the developer from the developer supply port to the developer accommodating portion,
by which the developer is fed from the developer supply port to fill the developer accommodating portion with the developer.

2. A method according to claim 1, wherein said injection step and said driving step are started simultaneously.

3. A method according to claim 1, wherein said injection step is started after said driving step is started.

4. A method according to claim 1, wherein in said injection step, the developer is injected with said developer supply port with such an orientation that of the developer supply unit that said developer supply port faces substantially up.

5. A method according to claim 1, wherein the feeding member rotates in a predetermined rotational direction to feed t developer in an axial direction of said feeding member when the developer is to be fed from the developer accommodating portion to the developer supply port, and in said driving step, the feeding member is rotated in a direction opposite to the predetermined rotational direction.

6. A method according to claim 1, wherein the developer supply unit has a coupling portion for engagement with a main assembly coupling portion provided in the main assembly of the image forming apparatus to transmit a driving force to the feeding member when the developer supply unit is mounted to the main assembly of the image forming apparatus, wherein in said driving step, a rotational driving force is transmitted from the coupling portion to the feeding member.

7. A method according to claim 6, wherein said driving step includes connecting a driving force generating device for generating a rotational driving force with the coupling portion to supply the rotational driving force to the feeding member from the driving force generating device.

8. A method according to claim 6, wherein said driving step includes connecting the coupling portion with a rotation drive transmission member, wherein the rotation drive transmission member is manually rotated to drive the feeding member.

9. A method according to claim 1, wherein the developer supply unit includes a supply port cover movable between an opening position for opening the developer supply port and a closing position for closing the developer supply port, wherein the supply port cover is engaged with the main assembly of the apparatus and is moved from t closing position to the opening position when the developer supply unit is mounted to the main assembly of the apparatus,
said method further comprising a supply port opening step of moving the supply port cover to the opening position.

10. A method according to claim 9, further comprising a supply port closing step of moving the supply port cover from the opening position to the closing position after said injection step.

11. A method according to claim 1, wherein said injection step includes a guiding member insertion step of inserting a guiding member through the developer supply port, wherein the developer is injected through the guiding member.
